(19) United States
(12) Patent Application Publication
(10) Pub. No.: US 2007/0280259 A1
(43) Pub. Date: Dec. 6, 2007

(54) Method and apparatus for scheduling transmissions on a wireless network

(76) Inventors: Joseph B. Bullock, Decatur, GA (US); Andrew R. Werback, San Jose, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/444,130

(22) Filed: May 31, 2006

(51) Int. Cl. H04L 12/56

(52) U.S. Cl. 370/395.4

(57) ABSTRACT

A wireless local area network (WLAN) includes a wireless access point coupled to a network; and a plurality of mobile units configured to receive incoming data packets from the wireless access point. Each mobile unit has an associated data rate, and the wireless access point includes a scheduling system that schedules the incoming data packets for transmission as outgoing data packets to the mobile units based at least in part on the data rates of the mobile units.

### TECHNICAL FIELD

The present invention relates generally to wireless networks and, more particularly, to a wireless network that fairly schedules transmissions.

### BACKGROUND

In recent years, there has been a dramatic increase in the demand for mobile connectivity solutions utilizing various wireless components and wireless networks, for example, wireless local area networks (WLANs). WLANs generally include, among other things, wireless access points that communicate with mobile units using one or more RF channels.

In a wireless network, a given RF channel is a shared resource. Each of the network devices operating on the RF channel must utilize a finite bandwidth. When several mobile units are connected to a common wireless infrastructure device, for example an access point, the mobile units receive their transmissions from the single access point on the same channel. The access point must make decisions about the order of transmissions to a potentially diverse group of mobile units.

Conventional access points may schedule transmissions based on a first in, first out (FIFO) scheduling system. This system is disadvantageous in that one mobile unit can dominate most of the bandwidth and cause significant delays in the delivery of the traffic of other mobile units.

Other conventional access points use a scheduling system that alternates transmissions between the mobile units in a round-robin fashion. In this scheduling system, even if one mobile unit is attempting to dominate the bandwidth of the RF channel, the amount of time for each mobile unit to receive a given packet is determined by the total number of units that a given access point is servicing and their respective transmission times. Although this scheduling system provides some level of fairness and consistency to the transmissions, problems arise when the data rates of the mobile units vary. As an example, if an access point alternates delivery of one packet to a mobile unit with a data rate of 1 Mbps and another packet to a different mobile unit with a data rate of 54 Mbps, the resulting throughput for both mobile units will approximate the throughput as if both mobile units had a data rate of 1 Mbps. As such, the mobile unit at 54 Mbps has its potential throughput severely degraded because another mobile unit is transmitting at a lower data rate.

Accordingly, it is desirable to provide a system and method that are capable of more effectively and fairly scheduling transmissions on a wireless network.

### BRIEF SUMMARY

In accordance with the present invention, a wireless local area network (WLAN) includes a wireless access point coupled to a network; and a plurality of mobile units configured to receive incoming data packets from the wireless access point. Each mobile unit can have an associated data rate, and the wireless access point may include a scheduling system that schedules the incoming data packets for transmission as outgoing data packets to the mobile units based at least in part on the data rates of the mobile units.

In accordance with another embodiment of the present invention, a method for scheduling transmissions on a wireless network includes receiving a plurality of incoming data packets for transmission to a plurality of mobile units, each having an associated data rate, scheduling the incoming data packets as outgoing data packets for transmission based at least in part on the data rates of the mobile units, and transmitting the outgoing data packets.

In accordance with yet another embodiment of the present invention, a scheduling system is provided for a wireless local area network (WLAN) having at least one access point that schedules incoming data packets to be transmitted to a plurality of mobile units as outgoing data packets. Each of the mobile units has an associated data rate and utilizes bandwidth of the access point when receiving the data packets. The scheduling system may include a data rate input for receiving the data rate of each mobile unit, a feedback input for evaluating the bandwidth utilization of each mobile unit, a queuing input for storing the incoming data packets, and a scheduler output that evaluates the incoming data packets and schedules the incoming data packets for transmission to a respective mobile unit based on the data rate of the respective mobile unit and the bandwidth utilization of the respective mobile unit.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network in accordance with an exemplary embodiment of the present invention;

FIG. 2 is a schematic representation of a scheduling system of an access point of the wireless network of FIG. 1;

FIG. 3 is a schematic representation of the data flow of the scheduling system according to one exemplary embodiment of the present invention; and

FIG. 4 is a flowchart depicting a method in accordance with one embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

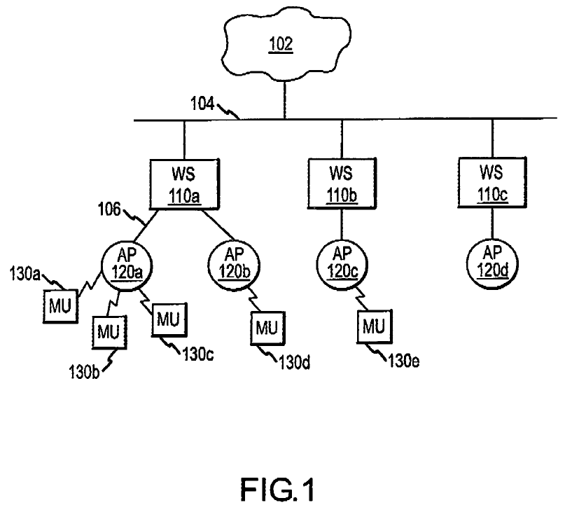

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access points 120 (alternatively referred to as “access ports” or “APs”) are configured to wirelessly connect to one or more mobile units 130 (alternatively referred to as “MUs”). The access points 120 are suitably connected to corresponding wireless switches 110 via communication lines 106 (e.g., conventional Ethernet lines). Any number of additional and/or intervening switches, routers, servers and other network components may also be present in the system.

A particular access point 120 may have a number of associated mobile units 130. For example, in the illustrated topology, mobile units 130(a), 130(b), and 130(c) are associated with access point 120(a), while mobile unit 130(e) is associated with access point 120(c). Furthermore, one or more access points 120 may be connected to a single wireless switch 110. Thus, as illustrated, access point 120(a) and access point 120(b) are connected to wireless switch 110(a), and access point 120(c) is connected to wireless switch 110(b).

Each wireless switch 110 determines the destination of data packets it receives over network 104 and routes that data packet to the appropriate access point 120 if the destination is a mobile unit 130 with which the access point 120 is associated. Each wireless switch 110 therefore maintains a routing list of mobile units 130 and their associated access points 130. These lists are generated using a suitable packet handling process known in the art. Thus, each access point 120 acts primarily as a conduit, sending/receiving RF transmissions via mobile units 130, and sending/receiving data packets via a network protocol with wireless switch 110.

The access points 120 are typically capable of communicating with one or more mobile units 130 through multiple RF channels. This distribution of channels varies greatly by device, as well as country of operation. For example, in one embodiment in accordance with 802.11(b) there are fourteen overlapping, staggered channels, each centered 5 MHz apart in the RF band, although only eleven channels may currently be used legally in the U.S.

In alternate embodiments, the wireless switches are not utilized, and the access points are connected directly to the network.

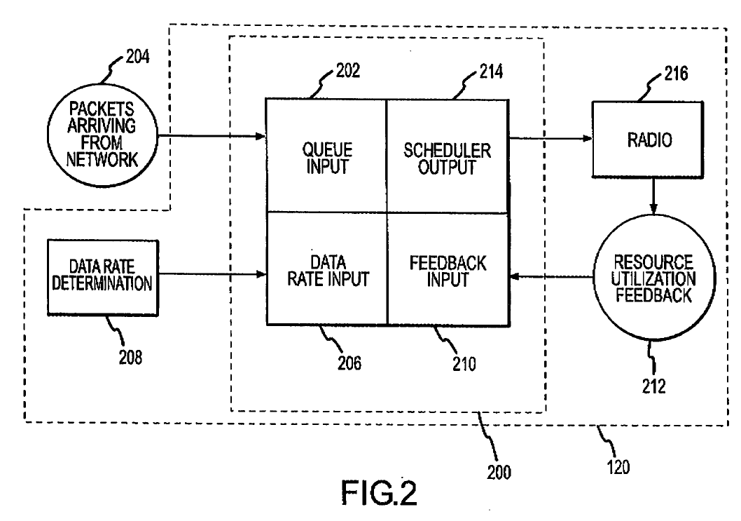

An exemplary embodiment of the present invention is described in conjunction with FIG. 2, which illustrates a scheduling system 200 of an access point 120. The scheduling system 200 includes a queue input 202 to receive incoming data packets 204 from the network 104 to be transmitted to the mobile units 130. In one embodiment, the queue input 202 includes a queue or set of queues for each individual mobile unit 130. This allows the scheduling system to differentiate between the intended destinations of the incoming data packets on the basis of the queues. As the data packets 204 flow into the scheduling system 200 from the network 204, the queues of the queue input 202 become filled with the data packets 204 for their respective mobile units. As further described below, the scheduling system 200 schedules the incoming data packets to be transmitted as outgoing data packets by a radio 216.

The scheduling system 200 further includes a data rate input 206. The data rate input 206 receives a data rate 208 assigned to transmit the data packet to a mobile unit 130. The data rate 208 can be determined by a data rate selection algorithm or mechanism, which may or may not form part of the data rate input 206 of the scheduling system 200. The mechanism by which the data rate is determined may vary based on the implementation of the access point 120.

The scheduling system 200 further includes a feedback input 210. The feedback input 210 may provide, receive and/or evaluate information about the resource utilization of the access point 120. The feedback input 210 can determine how much bandwidth a given mobile unit 130 is utilizing or has recently utilized. In the exemplary embodiment, the feedback input 210 receives resource utilization feedback 212 concerning the number of frames and bytes outgoing to a given mobile unit that are currently pending in the memory or queues of the radio 216. In an alternate embodiment, the feedback input 210 can use a timer to track the relative bandwidth utilization of each mobile unit over a given time interval. The resource utilization feedback 212 will vary as transmissions from the radio 216 are completed. Generally, the feedback input 210 provides the scheduling system 200 with an indication of how much a given mobile unit has been using the available network bandwidth.

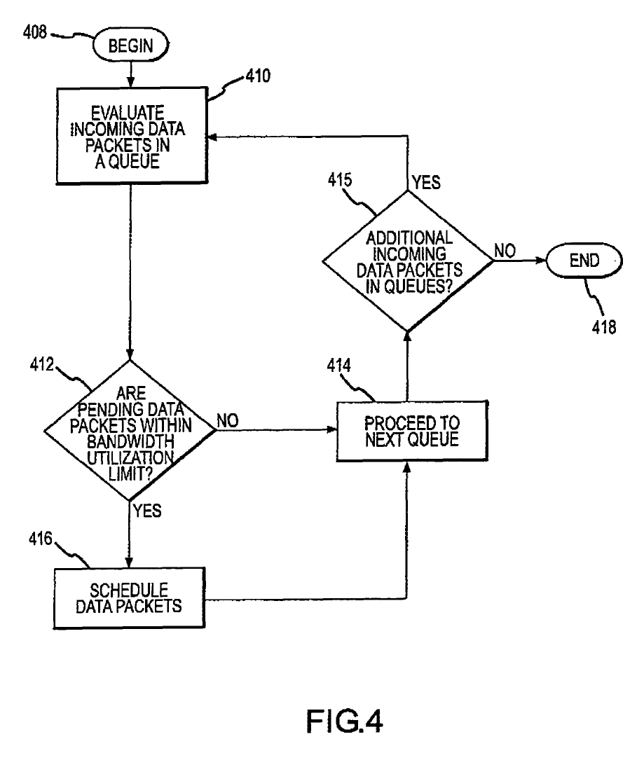

The scheduling system 200 further includes a scheduler output 214 that determines the schedule of data packets provided to the radio 216 for transmission. The process that the scheduler output 214 uses for determining the schedule of outgoing data packets is discussed in further detail with respect to FIG. 4. Generally, the scheduler output 214 schedules data packets based on the resource utilization information from the feedback input 210, an evaluation of the data packets in the queue input 202, and the data rate information from the data rate input 208. The scheduling system 200 may be implemented as hardware, software, firmware, or a combination thereof.

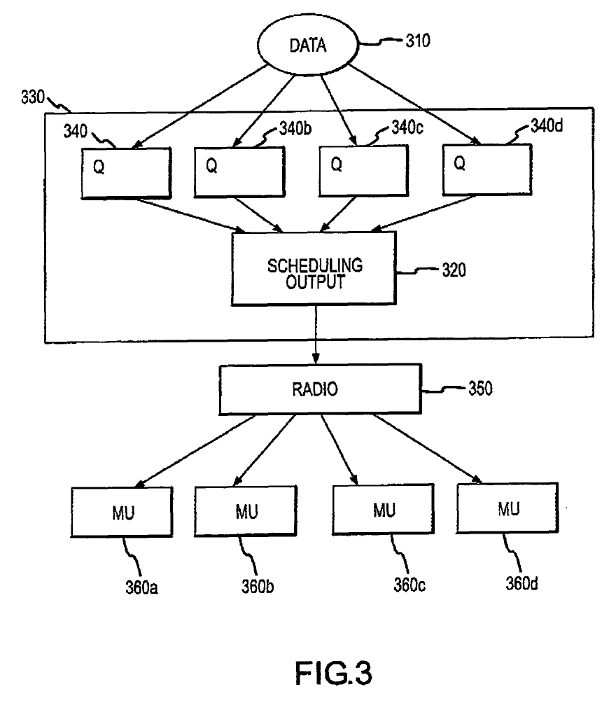

FIG. 3 illustrates a simplified, schematic representation of the data flow in one exemplary embodiment of the present invention. Data packets 310 flow into a scheduling system 330. The scheduling system 330 directs the data packets into an appropriate queue 340. Each queue 340 is associated with a particular mobile unit 360. A scheduling output 320 schedules the data packets in the queues 340 to be sent through the radio 350 in accordance with the exemplary embodiment discussed below with reference to FIG. 4. The radio 350 utilizes a shared RF medium to transmit the data packets. In this way, each of the data packets 310 is delivered to their respective mobile units 360.

Referring to the process steps illustrated in FIG. 4, the process begins in step 408. In step 410, the scheduler output 214 evaluates the incoming data packets pending in the queue input 202 for a particular mobile unit. In step 412, the scheduler output 214 evaluates whether to schedule the data packet for the mobile unit. In one embodiment, each mobile unit is assigned a bandwidth utilization limit. The bandwidth utilization limit for each mobile unit is usually maintained by the access point, and corresponds to the data rate for that mobile unit provided by the data rate input 206. The scheduler output 214 considers the bandwidth utilization of the mobile unit provided by the feedback input 210. In this embodiment, if the recent bandwidth utilization for that mobile unit exceeds or equals the bandwidth utilization limit for the current data rate, then the scheduler output 214 does not schedule any data packet for that mobile unit and proceeds to the queue for the next mobile unit, as shown in step 414. If the bandwidth utilization for that mobile unit is less than the bandwidth utilization limit, the scheduler output 214 schedules the data packet in the queue to be sent to the mobile unit associated with that queue, as shown in step 416. In step 415, the scheduling system determines whether there are additional incoming data packets in the queues to be evaluated. If yes, the process proceeds to evaluate the incoming data packets in the queue, as in step 410. If no, the process is complete in step 418. In alternate embodiments, the scheduler output 214 may schedule more than one of the packets in the queue.

As an example, the following scenario is considered: the queue input 202 indicates that a given queue has two packets, each 50 bytes long; the data rate input 206 indicates that the data rate assigned to the mobile unit associated with that queue is 1 Mbps; the bandwidth utilization limit for 1 Mbps is 150 bytes; and the feedback input 210 indicates that three data packets are already pending in the radio. In this scenario, the data packets of this queue will not be scheduled because the mobile unit's current bandwidth utilization equals the limit of 150 bytes. Instead, the data packets in the queue for the next mobile unit will be evaluated. Within one example of the system and method according to the present invention, the queues are evaluated in round robin manner, although other evaluation sequences and algorithms are possible. The two incoming data packets will not be scheduled until the data rate and the associated bandwidth utilization limit for that mobile unit is increased or the feedback input 210 indicates that at least one of the pending fames has completed transmission. If in another scenario, a queue has five data packets, each 50 bytes; the data rate is 11 Mbps; the bandwidth utilization limit is 1650 bytes; and no outgoing data packets are pending in the radio, then all five packets will be scheduled from that queue during the same interval as that of the three outgoing packets of the preceding queue.

In practice, the bandwidth utilization limit for different data rates can vary from implementation to implementation. Generally, the bandwidth utilization limits for different data rates will in fact vary based on the implementation because the ideal bandwidth utilization limits will depend upon the particular resource management feedback mechanism and the mechanism used for the determination of the data rate. Moreover, the bandwidth utilization limit of the different data rates can vary within the same implementation over time depending on environmental circumstances that affect the bandwidth utilization of a given data rate. For example, the bandwidth rating can vary based on whether 802.11(g) Extended Rate PHY protection is turned on or off. In one exemplary embodiment, the bandwidth utilization limits for a number of data rates are shown in Table 1 below.

TABLE 1

| Data Rate | Bandwidth Utilization Limit |
|---|---|
| 1 Mbps | 171 bytes |
| 2 Mbps | 341 bytes |
| 5.5 Mbps | 759 bytes |
| 6 Mbps | 1024 bytes |
| 9 Mbps | 1518 bytes |
| 11 Mbps | 1700 bytes |
| 12 Mbps | 2048 bytes |
| 18 Mbps | 3072 bytes |
| 24 Mbps | 3960 bytes |
| 36 Mbps | 6144 bytes |
| 48 Mbps | 8000 bytes |
| 54 Mbps | 9000 bytes |

The exemplary embodiment of the present invention may provide a fair and predictable distribution of transmissions to the mobile units. This holds true even if: (1) some of the mobile units may be attempting to dominate the bandwidth of the access point; (2) some of the mobile units are on the edge of the range, thereby forcing the access point to use a relatively low data rate; and/or (3) some of the mobile units are unable or incapable of using relatively high data rates.

The scheduling system described herein may be designed as a stand-alone device, incorporated into an access point coupled to a wireless switch, incorporated into the wireless switch itself, incorporated into an access point coupled directly to a network, or incorporated into a mobile unit. Components of the scheduling system can be located on a single element of a network or spread across more than one element of the network. Moreover, although the embodiments discussed above utilize the IEEE 802.11 protocol, the scheduling system can be implemented in any system that transmits to a variety of devices at different data rates on a shared medium.

It is noted that the various tasks performed in connection with the processes and systems shown herein may be performed by software, hardware, firmware, or any combination thereof. Although FIG. 2 illustrates that the components of the scheduling system 200 may be located in the access point, the components alternately may be located in the mobile units, the wireless switches, or in any combination thereof. Moreover, components of the scheduling system can be located in any portion of, for example, the access point. It should be appreciated that the processes and systems may include any number of additional or alternative tasks or components, that the tasks and components shown herein need not be performed or arranged in the illustrated order, and that the illustrated processes and systems may be incorporated into a more comprehensive system or process having additional functionality not described in detail herein.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A wireless local area network (WLAN) comprising:
a wireless access point coupled to a network; and
a plurality of mobile units configured to receive incoming data packets from the wireless access point, wherein each mobile unit has an associated data rate, and
wherein the wireless access point comprises a scheduling system that schedules the incoming data packets for transmission as outgoing data packets to the mobile units based at least in part on the data rates of the mobile units.

2. The WLAN of claim 1, wherein the scheduling system schedules the incoming data packets additionally based on an amount of bandwidth recently utilized by the mobile units.

3. The WLAN of claim 1, wherein the access point further comprises a radio with a queue for storing the outgoing data packets, and wherein the scheduling system schedules the incoming data packets additionally based on the outgoing data packets in the radio queue.

4. The WLAN of claim 1, wherein the wireless access point further comprises a radio for storing and transmitting the outgoing data packets to the mobile units,
wherein the scheduling system assigns a bandwidth utilization limit associated with each data rate, and
wherein the scheduling system evaluates incoming data packets and only schedules the incoming data packets for transmission to a respective mobile unit when the outgoing data packets for the respective mobile unit do not equal or exceed the bandwidth utilization limit.

5. The WLAN of claim 1, wherein the scheduling system comprises:
a data rate input for receiving the data rate of each mobile unit,
a feedback input for evaluating the outgoing data packets, and
a queuing input for storing the incoming data packets.

6. The WLAN of claim 5, wherein the queuing input stores the incoming data packets in queues associated with individual mobile units.

7. The WLAN of claim 1, wherein the scheduling system includes queues for storing the incoming data packets, wherein each mobile unit is associated with at least one queue, and wherein the scheduling system alternately evaluates the queues in a round robin manner.

8. The WLAN of claim 4, wherein the bandwidth utilization limits vary over time.

9. A method comprising the steps of:
receiving a plurality of incoming data packets for transmission to a plurality of mobile units, each of the mobile units having an associated data rate;
scheduling the incoming data packets as outgoing data packets for transmission based at least in part on the data rates of the mobile units; and
transmitting the outgoing data packets.

10. The method of claim 9, wherein the scheduling step includes scheduling the incoming data packets additionally based on an amount of bandwidth recently utilized by the mobile units.

11. The method of claim 9, further comprising storing the outgoing data packets in a radio queue prior to the transmitting step, and wherein the scheduling step further includes scheduling the incoming data packets additionally based on the outgoing data packets in the radio queue.

12. The method of claim 9, wherein the scheduling step includes evaluating the incoming data packets to be transmitted to a respective mobile unit and scheduling the incoming data packets for transmission if the outgoing data packets for the respective mobile unit do not exceed a bandwidth utilization limit.

13. The method of claim 9, wherein the receiving step includes storing the incoming data packets in queues associated with individual mobile units.

14. The method of claim 13, wherein the scheduling step includes alternately evaluating the queues in a round robin manner.

15. The method of claim 12, wherein the bandwidth utilization limits vary over time.

16. The method of claim 12, further comprising modifying the bandwidth utilization limits in a set of bandwidth utilization limits.

17. A scheduling system for a wireless local area network (WLAN) having at least one access point that schedules incoming data packets to be transmitted to a plurality of mobile units as outgoing data packets, each of the mobile units having an associated data rate and utilizing bandwidth of the access point when receiving the data packets, wherein the scheduling system comprises:
a data rate input for receiving the data rate of each mobile unit;
a feedback input for evaluating the bandwidth utilization of each mobile unit;
a queuing input for storing the incoming data packets; and
a scheduler output that evaluates the incoming data packets and schedules the incoming data packets for transmission to a respective mobile unit based on the data rate of the respective mobile unit and the bandwidth utilization of the respective mobile unit.

18. The scheduling system of claim 17, wherein each data rate for the mobile units has an associated bandwidth utilization limit, wherein the scheduler output will only schedule the data packets to a respective mobile unit if the respective mobile unit has not already met or exceeded its bandwidth utilization limit.

19. The scheduling system of claim 17, wherein the queuing input stores the incoming data packets in queues associated with individual mobile units.

20. The scheduling system of claim 17, wherein the queuing input stores the incoming data packets in queues associated with individual mobile units, and wherein the scheduling system alternately evaluates the queues in a round robin manner.
